(19) United States
(12) Patent Application Publication
(10) Pub. No.: US 2026/0155740 A1
(43) Pub. Date: Jun. 4, 2026

(54) SYSTEMS AND METHODS FOR HYBRID PHASE-SHIFT OPERATION OF INTERLEAVED PFC CONVERTERS

(71) Applicant: Navitas Semiconductor Limited, Dublin (IE)

(72) Inventors: Xiucheng HUANG, Torrance, CA (US); Weijing DU, Torrance, CA (US); Yun ZHOU, Shenzhen (CN)

(73) Assignee: Navitas Semiconductor Limited, Dublin (IE)

(21) Appl. No.: 19/452,815

(22) Filed: Jan. 19, 2026

Related U.S. Application Data
(63) Continuation of application No. 18/534,359, filed on Dec. 8, 2023, now Pat. No. 12,531,476.

(30) Foreign Application Priority Data
Dec. 16, 2022 (CN) 202211623223.4

(51) Int. Cl. H02M 1/42; H02M 1/00

(52) U.S. Cl. CPC H02M 1/4208; H02M 1/0043

(57) ABSTRACT

A method of operating a circuit is disclosed. The method includes providing an interleaved power factor correction (PFC) converter circuit; determining a switching frequency of the interleaved PFC converter circuit; setting a phase shift of the interleaved PFC converter circuit at a first phase shift when the switching frequency of the interleaved PFC converter circuit is below or at a first switching frequency; setting the phase shift of the interleaved PFC converter circuit at a second phase shift when the switching frequency of the interleaved PFC converter circuit is greater than the first switching frequency but less than a second switching frequency; and setting the phase shift of the interleaved PFC converter circuit at the first phase shift when the switching frequency of interleaved the PFC converter circuit is greater than the second switching frequency.

### CROSS-REFERENCE TO RELATED APPLICATIONS

This application is a continuation of U.S. patent application Ser. No. 18/534,359, for “SYSTEMS AND METHODS FOR HYBRID PHASE-SHIFT OPERATION OF INTERLEAVED PFC CONVERTERS” filed on Dec. 8, 2023, which claims priority to Chinese Patent Application No. 202211623223.4, filed on Dec. 16, 2022, entitled “METHOD FOR HYBRID PHASE-SHIFT CONTROL OF INTERLEAVED PFC CONVERTER”, the contents of which are incorporated herein by reference in their entirety for all purposes.

### FIELD

The described embodiments relate generally to power converters, and more particularly, the present embodiments relate to systems and methods for hybrid phase-shift control and operation of interleaved power factor correction (PFC) converters.

### BACKGROUND

Electronic devices such as computers, servers and televisions, among others, employ one or more electrical power conversion circuits to convert one form of electrical energy to another. Some electrical power conversion circuits use switching power supplies such as a flyback converter. Switching power supplies can efficiently convert power from a source to a load. Switching power supplies may have relatively high power conversion efficiency, as compared to other types of power converters. Switching power supplies may also be substantially smaller and lighter than a linear supply due to the smaller transformer size and weight.

### SUMMARY

In some embodiments, a method of operating a circuit is disclosed. The method includes providing an interleaved power factor correction (PFC) converter circuit; determining a switching frequency of the interleaved PFC converter circuit; setting a phase shift of the interleaved PFC converter circuit at a first phase shift when the switching frequency of the interleaved PFC converter circuit is below or at a first switching frequency; setting the phase shift of the interleaved PFC converter circuit at a second phase shift when the switching frequency of the interleaved PFC converter circuit is greater than the first switching frequency but less than a second switching frequency; and setting the phase shift of the interleaved PFC converter circuit at the first phase shift when the switching frequency of interleaved the PFC converter circuit is greater than the second switching frequency.

In some embodiments, the interleaved PFC converter circuit includes m channels that are coupled in parallel. In some embodiments, the m is equal to 2. In some embodiments, the method further includes determining the first switching frequency by dividing 150 kHz by m. In some embodiments, the method further includes determining the second switching frequency by dividing 150 kHz by m−1. In some embodiments, the method further includes determining the first phase shift by dividing 360° by m. In some embodiments, the method further includes determining the second phase shift by dividing 360° by m². In some embodiments, m is greater than 2. In some embodiments, the interleaved PFC converter circuit includes gallium nitride (GaN) based switches. In some embodiments, the interleaved PFC converter circuit includes silicon-based or silicon carbide based switches.

In some embodiments, a circuit is disclosed. The circuit includes an interleaved power factor correction (PFC) converter circuit, the interleaved PFC converter circuit arranged to: determine a switching frequency of the interleaved PFC converter circuit; set a phase shift of the interleaved PFC converter circuit at a first phase shift when the switching frequency of the interleaved PFC converter circuit is below or at a first switching frequency; set the phase shift of the interleaved PFC converter circuit at a second phase shift when the switching frequency of the interleaved PFC converter circuit is greater than the first switching frequency but less than a second switching frequency; and set the phase shift of the interleaved PFC converter circuit at the first phase shift when the switching frequency of interleaved the PFC converter circuit is greater than the second switching frequency.

### BRIEF DESCRIPTION OF THE DRAWINGS

FIG. 1 shows a schematic of a multi-phase interleaved PFC converter controlled with hybrid phase-shift control method, according to some embodiments;

FIG. 2 shows a graph for selecting a phase-shift angle θ of the interleaved PFC converter of FIG. 1, according to some embodiments;

FIG. 3 shows setting the phase-shift angle of the interleaved PFC converter of FIG. 1 to a first phase-shift angle when the switching frequency is higher than a first switching frequency or is lower than a second switching frequency, within half a line voltage cycle, according to some embodiments;

FIG. 4 shows setting the phase-shift angle of the interleaved PFC converter of FIG. 1 to a second phase-shift angle when the switching frequency is completely between a first switching frequency and a second switching frequency, according to some embodiments;

FIGS. 5A-5D show continuously changing the phase-shift angle of the interleaved PFC converter of FIG. 1 when there may be several operating conditions where the switching frequency changes with the amplitude of the line voltage, according to some embodiments;

FIG. 6 shows Fourier decomposition results of the input current Iᵢₙ in current approaches as compared to Fourier decomposition results of the input current Iᵢₙ of the interleaved PFC converter of FIG. 1, according to disclosed embodiments; and

FIG. 7 shows EMI test results for an interleaved PFC converter and its operating method, according to certain embodiments.

### DETAILED DESCRIPTION

Circuits, devices and related techniques disclosed herein relate generally to power converters. More specifically, circuits, devices and related techniques disclosed herein relate to systems and methods for hybrid phase-shift control and operation of interleaved PFC converters to reduce electromagnetic interference (EMI) performance of the converter. In some embodiments, the phase-shift angle of the interleaved PFC converter can be changed when a switching frequency of input AC line changes. As the switching frequency of the interleaved PFC converter changes, its phase-shift angle θ may be set to different values. In various embodiments, the switching frequency f_{sw} of the interleaved PFC converter can have two different frequency thresholds, i.e., a first switching frequency f_{sw_1} and a second switching frequency f_{sw_2}.

In some embodiments, the phase-shift angle θ may be set at a first phase-shift angle θ_{A} when the switching frequency of the interleaved PFC converter circuit is below or at a first switching frequency f_{sw_1}. The phase-shift angle θ may be set at a second phase-shift angle θ_{B} when the switching frequency of the interleaved PFC converter circuit is greater than the first switching frequency f_{sw_1} but less than the second switching frequency f_{sw_2}. The phase-shift angle θ may be set at the first phase shift θ_{A} when the switching frequency of interleaved the PFC converter circuit is greater than the second switching frequency f_{sw_2}. Embodiments of the disclosure can suppress the m^{th} and lower harmonic currents by operating the interleaved PFC converter with the first phase-shift angle θ_{A} and with the second phase-shift angle θ_{B}, thereby reducing the differential mode (DM) EMI of the interleaved PFC converter. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

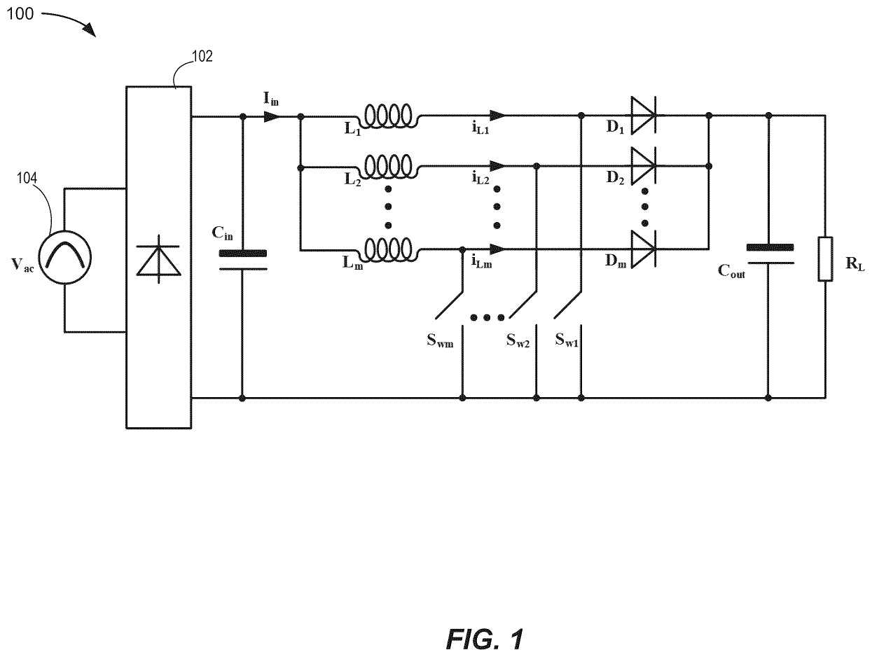

FIG. 1 shows a schematic of a multi-phase interleaved PFC converter 100 controlled with hybrid phase-shift control method, according to some embodiments. In a PFC converter, the phase-shift angle (θ) is defined as the phase-shift between the sinusoidal AC power supply voltage and current. The multi-phase interleaved PFC converter 100 can include several (m) channels that are coupled in parallel. The multi-phase interleaved PFC converter 100 can include a bridge rectifier 102 coupled to an AC input line 104 and an input capacitor Cin. The multi-phase interleaved PFC converter 100 can include a plurality of PFC inductors L₁, L₂, . . . . Lₘ, a plurality of switches S_{w1}, S_{w2} . . . . S_{wm} coupled to each corresponding PFC inductor, and a plurality of freewheeling diodes D₁, D₂ . . . . Dm coupled to each corresponding switch.

The outputs terminals of each of the freewheeling diodes D₁, D₂ . . . , Dm can be connected together and coupled to a load R_{L}, and an output capacitor Cout. Currents flowing through each PFC inductor are denoted as I_{L1}, I_{L2} . . . , and i_{Lm}. Iᵢₙ denotes a total current flowing into the multi-phase interleaved PFC converter 100, i.e., Iᵢₙ=i_{L1}+i_{L2}+ . . . +i_{Lm}. In some embodiments, the plurality of switches can be silicon based MOS transistors. In various embodiments, the plurality of switches can be silicon carbide based MOS transistors. In some embodiments, the plurality of switches can be gallium nitride (GaN) based switches.

In current approaches, in a multi-phase interleaved PFC converter the phase-shift angle θ may be fixed at 360°/m, where m is the number of channels of the PFC converter. For example, in a two-phase interleaved PFC converter m=2, in current approaches the phase-shift angle θ may be fixed at 360°/2=180°. Embodiments of the disclosure enable varying the phase-shift angle θ of the interleaved PFC converter such that a ripple of the input current Iᵢₙ may be reduced, and such that a Fourier decomposition of Iᵢₙ may not have odd harmonics. By not having odd numbered harmonics, the differential mode (DM) noise current of the interleaved PFC converter can be reduced. In this way, the interleaved PFC converter can use a differential mode inductor that may have relatively small volume, thereby improving the power density of the PFC converter and save system costs.

In current approaches, methods for controlling a PFC converter operating in a critical conduction mode (CrM) may include constant on-time (COT) control methods. In a line voltage cycle, a switching frequency of the PFC converter is not fixed and can change continuously with a change of the amplitude of the line voltage. In current approaches the switching frequency of the PFC converter (f_{sw}) may be continuously changing, and the control method of fixing the phase-shift angle θ at 360°/m cannot substantially reduce the differential mode noise of the PFC converter.

The inductor current i_{L} of the interleaved PFC converter may be a continuous periodic function and the expansion of its Fourier series is given by:

$${i}_{L} ( ω t ) = {a}_{0} + {\sum }_{n = 1}^{∞} {a}_{n} cos ( n ω t ) + {\sum }_{n = 1}^{∞} {b}_{n} sin ( n ω t ) \qquad ( 1 )$$

where a₀, aₙ, and bₙ are respectively:

$${a}_{0} = \frac{1}{2 π} {\int }_{0}^{2 π} u ( ω t ) d ( ω t ) \qquad ( 2 )$$

$${a}_{n} = \frac{1}{π} {\int }_{0}^{2 π} u ( ω t ) cos n ω td ( ω t )$$

$${b}_{n} = \frac{1}{π} {\int }_{0}^{2 π} u ( ω t ) sin n ω td ( ω t )$$

where ω=2πfs, and n=1, 2, 3 . . . .

When the phase-shift angle of the inductor current i_{L} is θ, the expansion of its Fourier series is:

$${i}_{L} ( ω t + θ ) = {a}_{0} + {\sum }_{n = 1}^{∞} {a}_{n} cos n ( ω t + θ ) + {\sum }_{n = 1}^{∞} {b}_{n} sin n ( ω t + θ ) \qquad ( 3 )$$

For a two-phase interleaved PFC converter (m=2), the input current is Iᵢₙ=i_{L1}+i_{L2}, and the expansion of its Fourier series is:

$${i}_{in} ( ω t ) = {i}_{L} ( ω t ) + {i}_{L} ( ω t + θ ) = 2 {a}_{0} + {\sum }_{n = 1}^{∞} {a}_{n} ( cos ( n ω t ) + cos n ( ω t + θ ) ) + {\sum }_{n = 1}^{∞} {b}_{n} ( sin ( n ω t ) + sin n ( ω t + θ ) ) = 2 {a}_{0} + {\sum }_{n = 1}^{∞} 2 {a}_{n} ( cos n ( ω t + \frac{θ}{2} ) cos ( n \frac{θ}{2} ) ) + {\sum }_{n = 1}^{∞} 2 {b}_{n} ( sin n ( ω t + \frac{θ}{2} ) cos ( n \frac{θ}{2} ) ) \qquad ( 4 )$$

It can be derived from equation (4) that the Fourier series expansion of the input current Iᵢₙ includes cos (n*θ/2). Therefore, when the phase-shift angle θ=180°, the expansion of the Fourier series may not include odd harmonics, and the proportion of the 2^{nd} harmonic can be the largest contributor. When the phase-shift angle θ=90°, the amplitude of the 2^{nd} harmonic is θ, but the amplitudes of the 1^{st} harmonic and the 3^{rd} harmonic are not 0. Similarly, for an m-phase interleaved PFC converter, when the phase-shift angle θ=360°/m, the expansion of the Fourier series may only include m*n harmonics, and the proportion of m^{th} harmonics is the largest. When the phase-shift angle θ=360°/m², the amplitude of the m^{th} harmonic is θ, but the amplitude of the (m±1)th harmonic current is not 0.

According to the EMC electromagnetic compatibility test standard CISPR22, the frequency test range of conducted EMI is 150 kHz to 30 MHz. Thus, if the frequency of a certain harmonic current of the input current Iᵢₙ is lower than 150 kHz, the harmonic current of this frequency is not within the frequency test range of conducted EMI. Therefore, this harmonic current may not cause conducted EMI problems. In various embodiments, a method for hybrid phase-shift control of interleaved PFC converter can substantially suppress the differential mode noise (DM EMI) of the interleaved PFC.

In some embodiments, the phase-shift angle of the interleaved PFC converter may not be fixed. As the switching frequency of the interleaved PFC converter changes, its phase-shift angle θ may be changed correspondingly. In various embodiments, the switching frequency f_{sw} of the interleaved PFC converter may have two different frequency thresholds, i.e., a first switching frequency f_{sw_1} and a second switching frequency f_{sw_2}. In some embodiments, the phase-shift angle θ of the interleaved PFC converter may include a first phase-shift angle θ_{A} and a second phase-shift angle θ_{B}. Embodiments of the disclosure can substantially suppress the m^{th} and lower harmonic currents by using control methods utilizing the first phase-shift angle θ_{A} and the second phase-shift angle θ_{B}, thereby reducing the differential mode noise (DM EMI) of the interleaved PFC converter.

The first switching frequency f_{sw_1}, the second switching frequency f_{sw_2}, the first phase-shift angle θ_{A}, and the second phase-shift angle θ_{B} may be expressed as:

$${f}_{sw \_ 1} = \frac{150 kHz}{m - 1}$$

$${f}_{sw \_ 2} = \frac{150 kHz}{m}$$

$${θ}_{A} = \frac{360 °}{m}$$

$${θ}_{B} = \frac{360 °}{{m}^{2}}$$

where m is a total number of channels of the interleaved PFC converter, and m≥2.

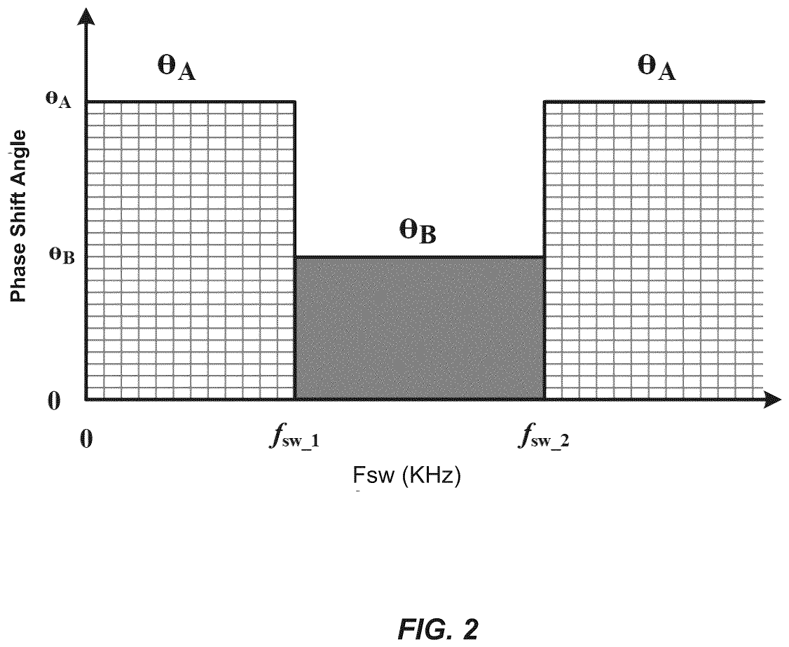

In some embodiments, a phase-shift angle θ can be selected according to a switching frequency of the interleaved PFC converter, as shown in FIG. 2. As shown in FIG. 2, when the switching frequency of the PFC converter exceeds the first switching frequency f_{sw_1} (f_{sw}≥f_{sw_1}) the phase-shift angle θ of the interleaved PFC converter can be arranged to be at a first phase-shift angle θ_{A} (θ=θ_{A}). Under this operating condition, the switching frequency of the interleaved PFC converter may be relatively high, and the frequency of the (m−1)^{th} harmonic current can appear the test range of conducted EMI (150 kHz to 30 MHz). By setting the phase-shift angle θ=θ_{A}, disclosed methods can cause the amplitude of the (m−1)^{th} harmonic current to be θ, thus the lowest frequency harmonic current detected by an EMI receiver may be the m^{th} harmonic current.

When the switching frequency of the PFC converter exceeds the second switching frequency f_{sw_2} but is lower than the first switching frequency f_{sw_1} (f_{sw_2}≤f_{sw}<f_{sw_1}), the phase-shift angle θ of the interleaved PFC converter may be set to the second phase-shift angle θ_{B} (θ=θ_{B}). Under this operating condition, the switching frequency of the interleaved PFC converter may be relatively low, and the frequency of the (m−1)^{th} harmonic current may less than 150 kHz. By setting the phase-shift angle θ=θ_{B} can cause the amplitude of the m^{th} harmonic current to be θ, and the EMI receiver may not detect the (m−1)^{th} harmonic current. The lowest frequency harmonic current detectible may be the (m±1)^{th} harmonic current.

When the switching frequency of the PFC converter is lower than the second switching frequency f_{sw_2} (f_{sw}<f_{sw_2}), the phase-shift angle θ of the interleaved PFC converter may be set to the first phase-shift angle θ_{A} (θ=θ_{A}). Under this operating condition, the switching frequency of the interleaved PFC converter is relatively very low, and by setting the phase-shift angle θ=θ_{A} can substantially reduce the differential mode noise (DM EMI) of the interleaved PFC converter.

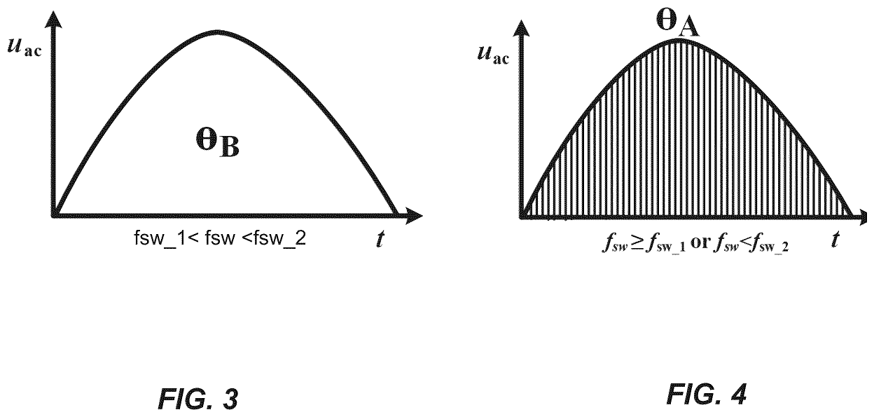

When the interleaved PFC converter is operating in the critical conduction mode, its switching frequency may change continuously with the amplitude of the line voltage. Within half a line voltage cycle, when the switching frequency f_{sw} is higher than the first switching frequency f_{sw_1} or is lower than the second switching frequency f_{sw_2}, then the phase-shift angle θ may be set to the first phase-shift angle θ_{A}, as shown in FIG. 3. When the switching frequency f_{sw} is completely between the first switching frequency f_{sw_1} and the second switching frequency f_{sw_2}, then the phase-shift angle within half a line voltage cycle may be set to second phase-shift angle θ_{B}, as shown in FIG. 4.

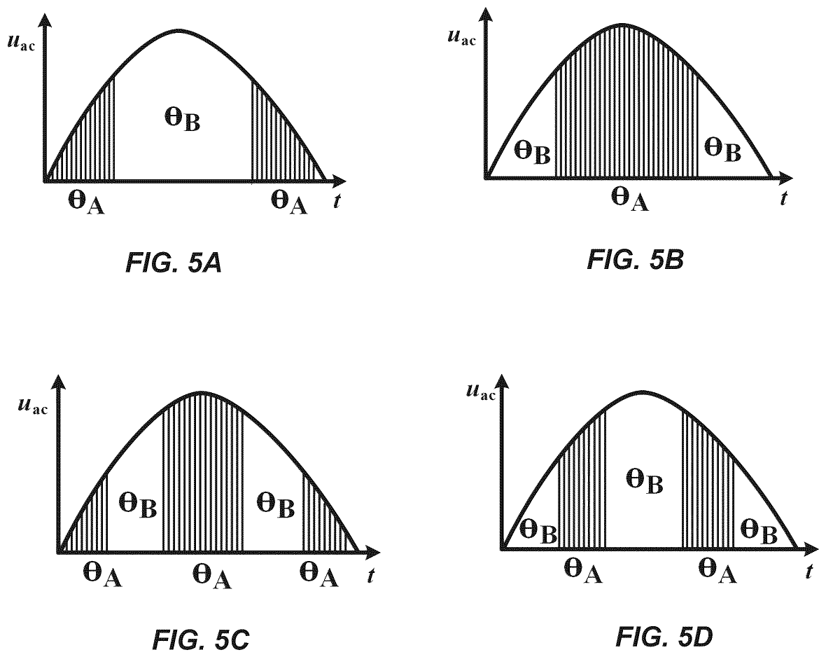

In some embodiments, when there may be several operating conditions where the switching frequency f_{sw} changes with the amplitude of the line voltage, then the phase-shift angle θ within half a line voltage cycle may be continuously changed, as shown in FIGS. 5A-5D.

### Example 1

The present invention will now be more fully described with reference to the accompanying examples. It should be understood, however, that the following description is illustrative only and should not be taken in any way as a restriction of the invention.

This embodiment includes application of disclosed methods to a two-phase interleaved PFC converter with a rated power of 300 W, an input voltage of 115 Vac, and an operating mode of critical conduction mode (CRM). When a line voltage rises from 0 V to 163 V, the switching frequency of the two-phase interleaved PFC converter drops from 300 kHz to 90 kHz. Disclosed embodiments include control methods having a first switching frequency f_{sw_1}, a second switching frequency f_{sw_2}, a first phase-shift angle θ_{A}, and a second phase-shift angle θ_{B}. In this embodiment m=2, and the first switching frequency f_{sw_1}, the second switching frequency f_{sw_2}, the first phase-shift angle θ_{A} and the second phase-shift angle θ_{B} can be respectively calculated as:

$${f}_{sw \_ 1} = \frac{150 kHz}{m - 1} = 150 kHz$$

$${f}_{sw \_ 2} = \frac{150 kHz}{m} = 75 kHz$$

$${θ}_{A} = \frac{360 °}{m} = 180 °$$

$${θ}_{B} = \frac{360 °}{{m}^{2}} = 90 °$$

In current approaches, in two-phase interleaved PFC converter, the phase-shift angle θ may be fixed at 180°. Therefore, when the switching frequency of the interleaved PFC converter drops from 300 kHz to 90 kHz, the phase-shift angle θ remains unchanged. Embodiments of the disclosure includes control methods where the phase-shift angle θ may be changed corresponding to changes in the switching frequency. When the switching frequency of the interleaved PFC converter is 90 kHz to 150 kHz, the phase-shift angle θ can be set to be 90°. When the switching frequency of the interleaved PFC converter is 150 kHz to 300 kHz, the phase-shift angle θ can be set to be 180°. At a switching frequency of f_{sw}=200 kHz, the magnitude of the first harmonic current is θ, and the lowest frequency harmonic current that can be detected by in EMI tester may be the second harmonic current, i.e., 400 kHz.

At a switching frequency of f_{sw}=100 kHz, the amplitude of the first harmonic current may not be zero, however the frequency of the first harmonic current is out of the EMI test frequency range. Therefore, the EMI receiver cannot detect the first harmonic current. However, the amplitude of the second harmonic current is θ, and the lowest frequency harmonic current that can be detected by the EMI receiver is the third harmonic current, i.e., the harmonic current of 300 kHz.

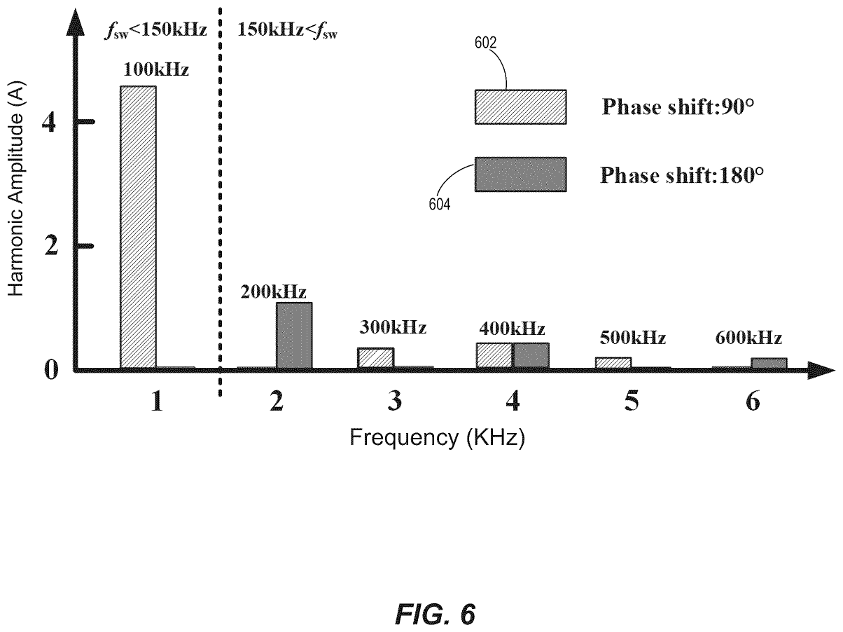

FIG. 6 shows Fourier decomposition results of the input current Iᵢₙ in current approaches as compared to Fourier decomposition results of the input current Iᵢₙ according to disclosed embodiments. FIG. 6 shows harmonic amplitude as a function of frequency (Fourier order). The hatched bars 602 show results of disclosed embodiments, while the solid bars 604 shows results of current approaches. In the illustrated example, the switching frequency of a two-phase interleaved PFC converter is f_{sw}=100 kHz, and the duty ratio D=0.4. As can be seen in FIG. 6, for current approaches an amplitude of the first harmonic current is θ, while the amplitude of the second harmonic current is at 200 kHz and has a relatively high amplitude. Results of disclosed hybrid phase-shift control methods shows that while an amplitude of the first harmonic current may not be zero, its frequency is at 100 kHz, which is out of the differential mode EMI testing range. Also, an amplitude of the second harmonic current is 0 and an amplitude of the third harmonic current is relatively smaller than the amplitude of the second harmonic current from current approaches. Thus, disclosed embodiments can substantially suppress the differential mode noise of the interleaved PFC converter.

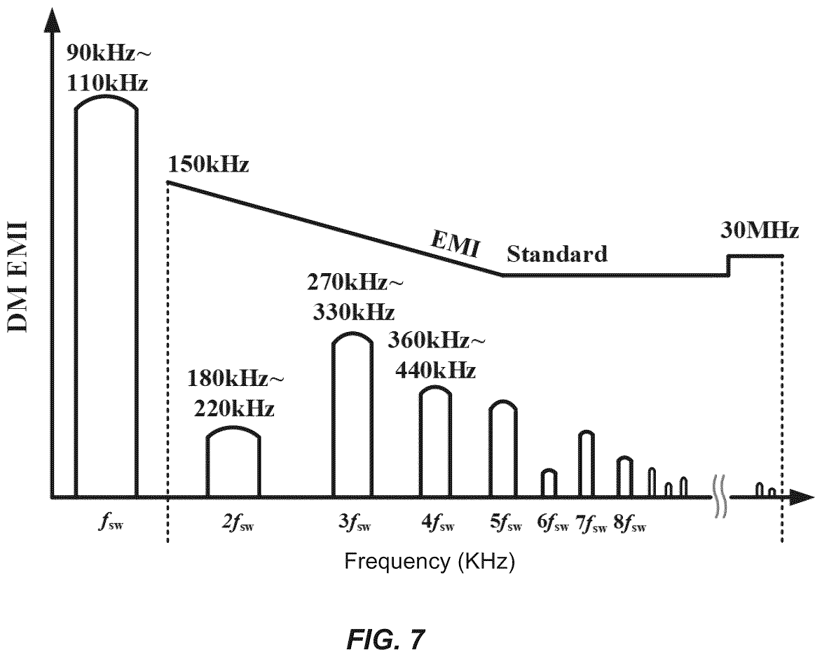

FIG. 7 shows EMI test results for an interleaved PFC converter and operating method, according to certain embodiments. In the illustrated example, when the switching frequency is 150 kHz to 300 kHz, the phase-shift angle θ is set at 180°, and when the switching frequency is 90 kHz to 150 kHz, the phase-shift angle θ is set at 90°. It can be seen from FIG. 7 that when the frequency of DM EMI is 90 KHz to 110 kHz, the amplitude of DM EMI is the highest compared to the other shown frequencies, however this frequency range, i.e., 90 kHz to 110 kHz is not within the EMI test range, therefore it does not affect the results of EMI testing. As can be seen, for the frequency range of 180 kHz to 220 kHz, the amplitude of DM EMI is relatively very low. Further, for the frequency range of 270 kHz to 330 kHz the amplitude of DM EMI may be relatively higher than at the other test frequencies, but it is well within the acceptable EMI test limits. Moreover, the test results at the other frequencies are also well within the acceptable EMI test limits. Therefore, disclosed embodiments can substantially reduce the amplitude of the differential mode noise of interleaved PFC converters. In this way, power density of the interleaved PFC converters can be improved.

In some embodiments, combination of the circuits and methods disclosed herein can be utilized for operating interleaved PFC converters. Although circuits and methods are described and illustrated herein with respect to several particular configuration of an interleaved PFC converter, embodiments of the disclosure are suitable for controlling and operating other power converter topologies, such as, but not limited to, flyback and LLC converters.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or.” and “an/or.” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example.” “an example.” “in certain examples.” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

1. (canceled)

2. A power converter circuit comprising:
a multi-phase converter circuit arranged to:
determine a switching frequency of the multi-phase converter circuit; and
dynamically adjust a phase shift between phases of the multi-phase converter circuit based on the switching frequency to reduce electromagnetic interference, wherein the phase shift is set to a first phase shift value when the switching frequency is in a first frequency range and set to a second phase shift value when the switching frequency is in a second frequency range different from the first frequency range.

3. The power converter circuit of claim 2, wherein the multi-phase converter circuit comprises an interleaved power factor correction converter circuit.

4. The power converter circuit of claim 2, wherein the multi-phase converter circuit comprises a plurality of channels, each channel including a switch and an inductor.

5. The power converter circuit of claim 2, wherein the first frequency range corresponds to switching frequencies below a first threshold frequency and the second frequency range corresponds to switching frequencies above a second threshold frequency.

6. The power converter circuit of claim 5, wherein the first phase shift value is 180 degrees divided by a number of phases in the multi-phase converter circuit.

7. The power converter circuit of claim 5, wherein the second phase shift value is selected to suppress m^{th} and lower harmonic currents in a Fourier decomposition of an input current.

8. The power converter circuit of claim 2, wherein the multi-phase converter circuit is configured to operate in critical conduction mode with constant on-time control.

9. The power converter circuit of claim 2, wherein the electromagnetic interference comprises differential mode electromagnetic interference in a frequency range from 150 kHz to 30 MHz.

10. The power converter circuit of claim 2, further comprising a bridge rectifier coupled to an AC input line and an input capacitor coupled to the bridge rectifier.

11. The power converter circuit of claim 2, wherein the multi-phase converter circuit is configured to reduce harmonic currents below electromagnetic interference test thresholds.

12. A method of operating a circuit, the method comprising:
operating a multi-phase power converter circuit having a plurality of phases;
determining a switching frequency of the multi-phase power converter circuit;
comparing the switching frequency to at least one frequency threshold; and
setting a phase shift between the plurality of phases based on the comparison to reduce electromagnetic interference, wherein the phase shift has a first value when the switching frequency is in a first frequency range and a second value when the switching frequency is in a second frequency range.

13. The method of claim 12, wherein the multi-phase power converter circuit comprises an interleaved power factor correction converter circuit.

14. The method of claim 12, wherein the first value comprises 180 degrees divided by a number of the plurality of phases.

15. The method of claim 12, wherein the second value is selected to suppress harmonic currents in a Fourier decomposition of an input current.

16. The method of claim 12, wherein the electromagnetic interference comprises differential mode electromagnetic interference in a frequency range from 150 kHz to 30 MHz.

17. The method of claim 12, further comprising operating the multi-phase power converter circuit in critical conduction mode with constant on-time control.

18. A power factor correction circuit comprising:
a plurality of channels, each channel including an inductor and a switch; and
a controller configured to:
operate the plurality of channels in critical conduction mode;
control the switches with constant on-time control;
vary a switching frequency based on an amplitude of an input AC line voltage; and
adjust a phase shift between the plurality of channels based on the switching frequency to reduce electromagnetic interference.

19. The power factor correction circuit of claim 18, wherein the controller is configured to set the phase shift to a first value when the switching frequency is below a frequency threshold and to a second value when the switching frequency is above the frequency threshold.

20. The power factor correction circuit of claim 18, wherein the controller is configured to suppress differential mode electromagnetic interference by adjusting the phase shift to eliminate harmonic currents in a frequency range from 150 kHz to 30 MHz.

21. The power factor correction circuit of claim 18, wherein the controller is configured to reduce harmonic currents below electromagnetic interference test thresholds by setting the phase shift to suppress m^{th} and lower harmonic currents in a Fourier decomposition of an input current.
